(19) United States
(12) Patent Application Publication
(10) Pub. No.: US 2025/0338188 A1
(43) Pub. Date: Oct. 30, 2025

(54) DATA PROCESSING METHOD AND APPARATUS, AND USER EQUIPMENT

(71) Applicant: SPREADTRUM COMMUNICATIONS (SHANGHAI) CO., LTD., Shanghai (CN)

(72) Inventor: Huayu ZHOU, Shanghai (CN)

(73) Assignee: SPREADTRUM COMMUNICATIONS (SHANGHAI) CO., LTD., Shanghai (CN)

(21) Appl. No.: 18/560,570

(22) PCT Filed: Dec. 7, 2021
(86) PCT No.: PCT/CN2021/136069

§ 371 Date: Apr. 29, 2024

(30) Foreign Application Priority Data
May 11, 2021 (CN) 202110511816.0

(51) Int. Cl. H04W 36/06; H04W 76/27

(52) U.S. Cl. CPC H04W 36/06; H04W 76/27

(57) ABSTRACT

A method and apparatus for processing data, and a user equipment (UE) are provided. The method for processing data includes: in response to a determination that a change in a first reference signal received power (RSRP) is less than a first threshold, or in response to a determination that changes in a plurality of first RSRPs are all less than a second threshold, or in response to a determination that changes in a plurality of first RSRPs are less than respective thresholds thereof, determining that a timing advance or timing alignment is valid. The present disclosure can improve data transmission quality of small data transmission (SDT) and reduce a power consumption of the UE.

### TECHNICAL FIELD

The present disclosure relates to the field of communications, and in particular to a method for processing data, an apparatus for processing data, and a user equipment (UE).

### BACKGROUND

As machine type communication (MTC) or the Internet of Things (IoT) is widely used, small data transmission (SDT) is an efficient transmission method. When a data volume is small, a user equipment (UE) can transmit and receive data in an inactive or idle state, without entering a connected state. This can avoid frequent establishment and release of radio resource control (RRC) connections, thereby reducing a power consumption of the UE.

Specifically, the UE can send data (such as a message 3) in a random access channel (RACH) process. The UE can also send data during configured grant (CG), and then perform subsequent transmission, retransmission, or reception. A multi-beam operation has been introduced in 5G. When the UE transmits and receives data in the inactive or idle state, multiple beams also need to be considered.

In a communication system using multiple beams, how to improve data transmission quality of the SDT and reduce the power consumption of the UE is a problem to be addressed.

### SUMMARY

The present disclosure provides a method and apparatus for processing data, and a UE, which can improve the quality of small data transmission and reduce the power consumption of the UE.

According to a first aspect, embodiments of the present disclosure provides a method for processing data. The method includes: determining that a timing advance or timing alignment is valid in response to a determination that a change in a first reference signal received power (RSRP) is less than a first threshold, or in response to a determination that changes in a plurality of first RSRPs are all less than a second threshold, or in response to a determination that changes in a plurality of first RSRPs each are less than a respective threshold corresponding thereto.

In this method, during the SDT, in response to a determination that a change in a first RSRP is less than a first threshold, or in response to a determination that changes in a plurality of first RSRPs are all less than a second threshold, or in response to a determination that changes in a plurality of first RSRPs each are less than a respective threshold corresponding thereto, it is determined that the timing advance or the timing alignment is valid, and the SDT continues. Otherwise, it is determined that the timing advance or the timing alignment is invalid, and the SDT is terminated. In this way, the quality of the SDT is improved, and an additional power consumption of the UE due to a data transmission failure is avoided.

In some embodiments, the first RSRP is a linear average of RSRPs of a synchronization signal block (SSB) subset.

In some embodiments, the SSB subset is composed of SSBs whose RSRPs exceed a third threshold.

In some embodiments, the third threshold is used to select an uplink configured-grant (CG) transmission resource.

In some embodiments, the SSB subset is composed of SSBs in a configured grant configuration.

In some embodiments, the SSB subset is composed of SSBs, whose RSRPs exceed a fourth threshold, in a configured grant configuration.

In some embodiments, the fourth threshold is used to select an uplink CG transmission resource.

According to a second aspect, embodiments of the present disclosure provides a method for processing data. The method includes: selecting a random access channel based small data transmission (RA-SDT) or a non-SDT.

In some embodiments, the selecting the RA-SDT or the non-SDT includes selecting the RA-SDT or the non-SDT in response to a determination that a timing advance or timing alignment is invalid.

In some embodiments, the selecting the RA-SDT or the non-SDT includes: selecting the RA-SDT or the non-SDT in response to receiving a switching instruction.

In some embodiments, the selecting the RA-SDT or the non-SDT includes: autonomously selecting the RA-SDT or the non-SDT.

In some embodiments, the selecting the RA-SDT or the non-SDT includes: selecting the RA-SDT or the non-SDT in response to a determination that RSRPs of SSBs in a first SSB subset are all less than a fifth threshold, where the first SSB subset is composed of an SSB associated with an uplink CG transmission resource.

In some embodiments, the selecting the RA-SDT or the non-SDT includes: in response to a determination that a maximum RSRP of SSBs in a second SSB subset is greater than a maximum RSRP of SSBs in a first SSB subset, selecting the RA-SDT or the non-SDT, wherein the first SSB subset is composed of SSBs associated with an uplink CG transmission resource, and the second SSB subset is composed of SSBs not associated with the uplink CG transmission resource.

In some embodiments, the selecting the RA-SDT or the non-SDT includes: in response to a determination that a difference between a maximum RSRP of SSBs in a second SSB subset and a maximum RSRP of SSBs in a first SSB subset is greater than a sixth threshold, selecting the RA-SDT or the non-SDT, where the first SSB subset is composed of SSBs associated with an uplink CG transmission resource, and the second SSB subset is composed of SSBs associated not with the uplink CG transmission resource.

According to a third aspect, embodiments of the present disclosure provide a method for processing data. The method includes: determining an association relationship between a tracking reference signal (TRS) and an uplink CG transmission resource.

In some embodiments, said determining the association relationship between the TRS and the CG-based uplink transmission resource comprises: the determining the association relationship between the TRS and the uplink CG transmission resource includes: determining the association relationship between the TRS and the uplink CG transmission resource based on a CG configuration.

In some embodiments, the determining the association relationship between the TRS and the uplink CG transmission resource includes: determining the association relationship between the TRS and the uplink CG transmission resource based on a CG configuration and a rule for mapping between the TRS and the uplink CG transmission resource.

In some embodiments, the determining the association relationship between the TRS and the uplink CG transmission resource includes: determining the association relationship between the TRS and the uplink CG transmission resource based on a CG configuration, a rule for mapping between an SSB and the uplink CG transmission resource, and a quasi-colocation (QCL) relationship between the TRS and an SSB.

According to a fourth aspect, embodiments of the present disclosure provide a method for processing data. The method includes: switching a bandwidth part (BWP).

In some embodiments, the switching the BWP includes: in response to initiating of a SDT, switching to or activating a non-initial active BWP.

In some embodiments, the switching the BWP includes: in response to ending of a SDT or releasing of radio resource control (RRC), switching to an initial active BWP or activating a non-initial-active BWP.

In some embodiments, the switching the BWP includes: in response to initiating of a SDT, switching to or activating a non-initial-active downlink BWP.

In some embodiments, the switching the BWP includes: in response to ending of a SDT or releasing of RRC, switching to an initial active downlink BWP or activating a non-initial-active downlink BWP.

According to a fifth aspect, embodiments of the present disclosure provide an apparatus for processing data, including: a determining unit.

The determining unit is configured to: determine that a timing advance or timing alignment is valid in response to a determination that a change in a first RSRP is less than a first threshold, or in response to a determination that changes in a plurality of first RSRPs are all less than a second threshold, or in response to a determination that changes in a plurality of first RSRPs each are less than a respective threshold corresponding thereto.

According to a sixth aspect, embodiments of the present disclosure provide an apparatus for processing data, including: a selection unit.

The selection unit is configured to select RA-SDT or non-SDT.

According to a seventh aspect, embodiments of the present disclosure provide an apparatus for processing data, including: a determining unit.

The determining unit is configured to determine an association relationship between a TRS and an uplink CG transmission resource.

According to an eighth aspect, embodiments of the present disclosure provide an apparatus for processing data, including: a switching unit.

The switching unit is configured to switch a BWP.

According to a ninth aspect, embodiments of the present disclosure provide a chip module, including the apparatus for processing data according to any one of the fifth aspect to the eighth aspect.

According to a tenth aspect, embodiments of the present disclosure provide a user equipment (UE), including: one or more processors, a memory, and one or more computer programs, where the one or more computer programs are stored in the memory and include instructions, and the instructions, when executed by the UE, cause the UE to perform the method.

According to an eleventh aspect, embodiments of the present disclosure provide a computer-readable storage medium. The computer-readable storage medium stores a computer program, and the computer program, when running on a computer, causes the computer to perform the method according to any one of the first aspect to the fourth aspect.

According to a twelfth aspect, embodiments of the present disclosure provide a computer program. The computer program, when executed by a computer, causes the computer to perform the method according to any one of the first aspect to the fourth aspect.

In some embodiments, the program in the twelfth aspect can be stored entirely or partially on a storage medium packaged with a processor, or partially or entirely on a memory not packaged with the processor.

According to a thirteenth aspect, embodiments of the present disclosure provide a computer program product. The computer program product includes a computer program, and the computer program, when running on a computer, causes the computer to perform the method according to any one of the first aspect to the fourth aspect.

### BRIEF DESCRIPTION OF DRAWINGS

To describe the technical solutions in the embodiments of the present disclosure more clearly, the following briefly describes the accompanying drawings used in the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a flowchart of a method for processing data according to an embodiment of the present disclosure;

FIG. 2 is a flowchart of a method for processing data according to another embodiment of the present disclosure;

FIG. 3 is a flowchart of a method for processing data according to another embodiment of the present disclosure;

FIG. 4 is a flowchart of a method for processing data according to another embodiment of the present disclosure;

FIG. 5 is a flowchart of a method for processing data according to another embodiment of the present disclosure;

FIG. 6 is a flowchart of a method for processing data according to another embodiment of the present disclosure;

FIG. 7 is a flowchart of a method for processing data according to another embodiment of the present disclosure;

FIG. 8 is a flowchart of a method for processing data according to another embodiment of the present disclosure;

FIG. 9 is a flowchart of a method for processing data according to another embodiment of the present disclosure;

FIG. 10 is a flowchart of a method for processing data according to another embodiment of the present disclosure;

FIG. 11 is a structural diagram of an apparatus for processing data according to an embodiment of the present disclosure;

FIG. 12 is a structural diagram of an apparatus for processing data according to another embodiment of the present disclosure;

FIG. 13 is a structural diagram of an apparatus for processing data according to another embodiment of the present disclosure; and

FIG. 14 is a structural diagram of an apparatus for processing data according to another embodiment of the present disclosure.

### DESCRIPTION OF EMBODIMENTS

The terms used in the embodiments of the present disclosure are used only to explain the specific embodiments of the present disclosure, and are not intended to limit the present disclosure.

In a 5G communication system, a synchronization signal and a broadcast channel are sent through a synchronization signal block (SSB), and a function of beam sweeping is introduced. A primary synchronization signal (PSS), a secondary synchronization signal (SSS), and a physical broadcast channel (PBCH) are located in the SSB (SS/PBCH block). Each SSB can be regarded as a resource for one beam (analog domain) in a beam sweeping process. A plurality of SSBs form a synchronization signal burst (SS burst). The SS burst can be regarded as a relatively concentrated resource containing a plurality of beams. A plurality of SS bursts form an SS burst set. The SSB is repeatedly sent on different beams, which is one beam scanning process. Through beam sweeping training, a UE can know the signal received on which beam is strongest.

Small data transmission (SDT) is an efficient transmission method. In the case of a small data volume, a UE can send and receive data in an inactive or idle state without entering a connected state. This can avoid frequent establishment and release of radio resource control (RRC) connections, thereby reducing a power consumption of the UE. Specifically, the UE can send data (such as a message 3) in a random access channel (RACH) process, which is referred to as RACH-based SDT (RA-SDT). The UE can also send data during a configured grant, which is referred to as CG-based SDT (CG-SDT). A CG configuration (such as ConfiguredGrantConfig) includes an uplink configured-grant (CG) transmission resource, namely a physical uplink shared channel (PUSCH) resource. The PUSCH resource, also known as a PUSCH resource unit, may include a PUSCH transmission occasion, a PUSCH demodulation reference signal (DMRS) resource index (the PUSCH DMRS resource index may be composed of a PUSCH DMRS port and a PUSCH DMRS sequence), and the like. A multi-beam operation has been introduced in 5G. When the UE performs the SDT in the inactive or idle state, multiple beams also need to be considered. Generally, the uplink CG transmission resource needs to be associated with a synchronization signal block (SSB). A process of selecting the uplink CG transmission resource by the UE is as follows. When reference signal received power (RSRP) of one SSB exceeds a preset threshold, the UE selects an uplink CG transmission resource associated with the one SSB for uplink transmission.

In a communication system using multiple beams, how to improve data transmission quality of the SDT and reduce the power consumption of the UE is a problem to be addressed.

Therefore, the present disclosure provides a method for processing data, an apparatus for processing data, and a UE, to improve the data transmission quality of the SDT and reduce the power consumption of the UE.

The present disclosure can be applied to communication systems that use the multi-beam operation. For example, the communication system may be 5G, MTC, IoT, and the like. The UE described in the present disclosure may include, but is not limited to, a handheld device with a wireless communication function, a vehicle-mounted device, a wearable device, and the like. A network-side device described in the present disclosure may be a base station. In different communication systems, implementation types of the base station may be different, which is not limited in the present disclosure.

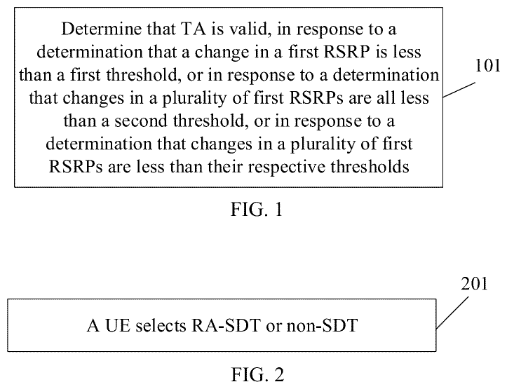

FIG. 1 is a flowchart of a method for processing data according to an embodiment of the present disclosure. As shown in FIG. 1, the method may include following steps.

In step 101, it is determined that a timing advance (TA) or timing alignment (TA) is valid in response to a determination that a change in a first RSRP is less than a first threshold, or in response to a determination that changes in a plurality of first RSRPs are all less than a second threshold, or in response to a determination that changes in a plurality of first RSRPs are less than respective thresholds thereof.

The timing advance generally refers to a time advance of uplink timing of sending uplink data by a UE compared with corresponding downlink timing of receiving downlink data. A specific value of the timing advance can be calculated by a network-side device based on a physical random access channel (PRACH), a random access preamble, or a message 1 (Msg1) sent by the UE, and notified to the UE using a timing advance command (TAC). When the timing advance is valid, a value of the timing advance is within an allowed range of a system or does not need to be adjusted.

The timing alignment, also known as uplink timing alignment, generally refers to achieving time alignment of uplink sending at a receiving end through the timing advance to reduce interference at the receiving end when a plurality of UEs send uplink signals. When the timing alignment is valid, the uplink timing alignment is valid, or the UE is in an uplink timing aligned state.

During data transmission, as the UE moves, a distance between the UE and the network-side device may change. Correspondingly, the time advance of the uplink timing of sending the uplink data by the UE compared with the corresponding downlink timing of receiving the downlink data also changes. If this change reaches a certain level, a timing advance used for SDT cannot match an actual time advance. As a result, the SDT may fail, which increases a power consumption of the UE, and may also cause interference to data transmission of another UE. Therefore, in this step, whether the timing advance or the timing alignment used for the SDT is valid is determined during the SDT. In response to a determination that the timing advance or the timing alignment used for the SDT is valid, the SDT with the network-side device can be maintained. In response to a determination that the timing advance or the timing alignment is invalid, the timing advance may be re-obtained, or the SDT may be terminated, to avoid an additional power consumption of the UE due to a data transmission failure and reduce interference to the another UE.

The determining whether the timing advance or the timing alignment is valid is particularly suitable for CG-SDT, because the message 1, the preamble, or the PRACH of the RACH process which is used by a base station for estimating the uplink timing advance and controlling the UE to adjust the uplink timing is not sent. Therefore, for the CG-SDT, the UE particularly needs to keep the timing advance or the timing alignment valid.

Determining whether the timing advance is valid is taken as an example. In another embodiment provided in the present disclosure, the method for processing data in the present disclosure may include the following step.

The UE determines whether the change in the first RSRP is less than the first threshold. In response to a determination that the change in the first RSRP is less than the first threshold, the UE determines that the timing advance is valid. In response to a determination that the change in the first RSRP is not less than the first threshold, the UE determines that the timing advance is invalid. The change is a change relative to a reference value. The change in the first RSRP is a change of the first RSRP relative to a reference value of the first RSRP. The reference value of the first RSRP may be indicated by the base station or a first RSRP measured at a preset time point. The preset time point may be a time point when a CG configuration is received by the UE, or a time point when an uplink CG transmission resource is selected by the UE, or a time point when an SSB associated with an uplink CG resource is selected by the UE, or a time point when an SSB subset corresponding to the first RSRP is selected by the UE.

For the CG-SDT, the first RSRP in this step may be a linear average RSRP of one SSB subset.

The linear average RSRP of one SSB subset is a linear average of RSRPs of SSBs included in one SSB subset.

In a first embodiment, the one SSB subset may be constituted by SSBs whose RSRPs exceed a third threshold. In an example, the one SSB subset may be constituted by SSBs that are actually sent by the base station and their RSRPs exceed the third threshold, and the third threshold may be configured by the base station.

The SSBs whose RSRPs exceed the third threshold represents a plurality of strongest SSBs, and a linear average of RSRPs of the plurality of strongest SSBs can represent a downlink path loss of the UE. In addition, the downlink path loss of the UE can indicate the distance between the UE and the network-side device such as the base station. Therefore, a change in the linear average RSRP of the SSB subset can be used to determine whether the timing advance is valid.

In another embodiment, the one SSB subset may be constituted by one or more RSRP-strongest SSBs. In an example, the one SSB subset may be constituted by one or more RSRP-strongest SSBs selected from SSBs actually sent by the base station.

In this embodiment, a reference time point and a determining time point may be included. At the reference time point and the determining time point, the UE can measure an RSRP of each SSB to obtain an RSRP of each SSB at the reference time point and an RSRP of each SSB at the determining time point. The SSB subset may be determined by the UE based on the RSRP of each SSB at the reference time point. After the SSB subset is determined, the UE may calculate the linear average RSRP of the SSB subset based on the RSRPs of the SSBs in the SSB subset at the reference time point to obtain a first RSRP at the reference time point. The UE may calculate the linear average RSRP of the SSB subset based on the RSRPs of the SSBs in the SSB subset at the determining time point to obtain a first RSRP at the determining time point. The change in the first RSRP can be calculated based on the first RSRP at the reference time point and the first RSRP at the determining time point. It should be noted that a time length between the reference time point and the determining time point is not limited in the present disclosure. The reference time point and the determining time point may dynamically change over time. For example, the reference time point and the determining time point may be determined based on a preset cycle, and then a change in the first RSRP within one cycle can be calculated.

In implementation second embodiment, the one SSB subset may be constituted by SSBs contained in one CG configuration. When the UE has a plurality of CG configurations, the UE has a plurality of SSB subsets, and a plurality of first RSRPs can be measured.

The CG configuration may be achieved by RRC configuration signaling used by the network-side device to send the uplink CG transmission resource.

A current uplink CG transmission resource of the UE is only related to the SSB included in the CG configuration. Therefore, whether a timing advance of the current uplink CG transmission resource is valid may only be related to the SSB included in the CG configuration. Therefore, whether the timing advance is valid can be determined by a change in the linear average RSRP of the SSB subset.

In a third embodiment, the one SSB subset may be constituted by SSBs whose RSRPs exceed a fourth threshold in one CG configuration. In an example, the one SSB subset may be constituted by SSBs selected from SSBs in one CG configuration, and the fourth threshold may be configured by the base station. In another example, the one SSB subset may be selected from one CG configuration, and the fourth threshold may be a threshold used by the UE to select the CG configuration or a threshold used by the UE to select an uplink CG transmission resource in the CG configuration. That is, when an RSRP of one SSB exceeds the fourth threshold, the UE selects the uplink CG transmission resource in a CG configuration associated with the one SSB for uplink transmission.

In another embodiment, the one SSB subset may be constituted by one or more RSRP-strongest SSBs in one CG configuration. In an example, the one SSB subset may be constituted by one or more RSRP-strongest SSBs in one CG configuration.

This embodiment is a combination of the first and second embodiments, and has advantages of the first and second embodiments. For a specific principle, reference may be made to the corresponding description of the first and second embodiments, and details are not described herein again.

In still another embodiment provided in the present disclosure, the method for processing data in the present disclosure may include the following steps.

The UE determines whether the changes in the plurality of first RSRPs are all less than the second threshold. In response to a determination that the changes in the plurality of first RSRPs are all less than the second threshold, the UE determines that the timing advance is valid. In response to a determination that the changes in the plurality of first RSRPs are not all less than the second threshold, the UE determines that the timing advance is invalid.

In the above embodiment, all the changes in the plurality of first RSRPs correspond to a same threshold. In till another embodiment provided in the present disclosure, the changes in the plurality of first RSRPs may correspond to different thresholds. In this case, the method for processing data in the present disclosure may include the following steps.

The UE determines whether the changes in the plurality of first RSRPs are all less than respective thresholds thereof. In response to a determination that the changes in the plurality of first RSRPs are all less than respective thresholds thereof, the UE determines that the timing advance is valid. In response to a determination that the changes in the plurality of first RSRPs are not all less than respective thresholds thereof, the UE determines that the timing advance is invalid.

Each of the plurality of first RSRPs may be a linear average RSRP of one SSB subset.

The plurality of first RSRPs correspond to a plurality of SSB subsets. For the implementation of each of the plurality of SSB subsets, reference may be made to the second and third embodiments for one SSB subset, and details are not described herein again.

Under a multi-beam condition, a linear average RSRP of the plurality of SSB subsets can better indicate radial movement, under a narrow-beam condition, of the UE relative to the network-side device such as the base station. Because the changes in the plurality of first RSRPs corresponding to the plurality of SSB subsets are all less than a threshold, it is likely that the distance between the UE and the network-side device does not change greatly, which indicates that the timing advance is valid. Otherwise, it indicates that the distance between the UE and the network-side device changes significantly, which indicates that the timing advance is invalid.

Specific values of the thresholds involved in the above embodiments are not limited in the embodiments of the present disclosure. The thresholds may be the same or different, which is not limited in the embodiments of the present disclosure.

The above embodiments describe examples of determining whether the timing advance is valid. For a method for determining whether the timing alignment is valid, reference may be made to the above embodiments by replacing the timing advance with the timing alignment, and details are not described herein again.

The method for processing data in the present disclosure determines, during the SDT, validity of the timing advance or the timing alignment used for the SDT. In response to a determination that the timing advance or the timing alignment is invalid, the SDT is terminated and the timing advance is re-obtained to avoid the data transmission failure caused by invalidity of the timing advance or the timing alignment. This avoids the additional power consumption of the UE due to the data transmission failure, and can also reduce the interference to the data transmission of another UE when the UE performs data transmission using the invalid timing advance or timing alignment.

In the CG SDT, the UE sends small data using an RRC-configured CG. In RA-SDT, the UE needs to send the message 1, receive a message 2 (Msg2), and then sends a message 3. Therefore, the UE performs more processing procedures and consumes more power in the RA-SDT compared with the CG-SDT. Therefore, under the multi-beam condition, how the UE selects a data transmission method to reduce the power consumption of the UE is a problem to be addressed. The above data transmission method may be the RA-SDT, the CG-SDT, or non-SDT. The non-SDT is to use a data transmission method other than the SDT to perform data transmission between the UE and the network-side device. A specific data transmission method is not limited in the present disclosure.

FIG. 2 is a flowchart of a method for processing data according to an embodiment of the present disclosure. As shown in FIG. 2, the data processing method may include the following step.

In step 201, a UE selects RA-SDT or non-SDT.

Implementation of the method of FIG. 2 is exemplarily described below using a specific embodiment.

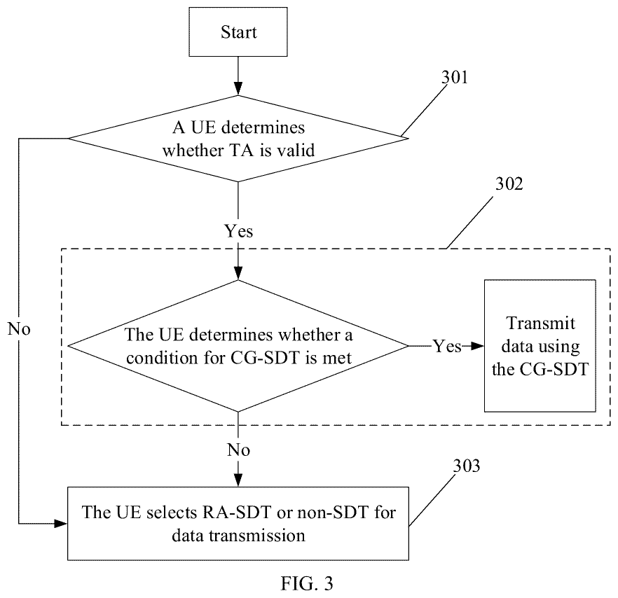

FIG. 3 is a flowchart of a method for processing data according to an embodiment of the present disclosure. As shown in FIG. 3, the data processing method may include following steps.

In step 301, in response to a determination that data transmission needs to be performed, a UE determines whether a timing advance or timing alignment is valid. In response to a determination that the timing advance or the timing alignment is valid, step 302 is performed. In response to a determination that the timing advance or the timing alignment is invalid, step 303 is performed.

For a method used by the UE to determine whether the timing advance or the timing alignment is valid, reference may be made to the aforementioned embodiments, and details are not described herein again.

In step 302, the UE determines whether a condition for CG-SDT is met. In response to a determination that the condition for the CG-SDT is met, the CG-SDT is used for the data transmission, and this process ends. In response to a determination that the condition for the CG-SDT is not met, the step 303 is performed.

In the step 303, the UE selects RA-SDT or non-SDT for the data transmission.

It should be noted that an execution order of the two determining steps in the steps 301 and 302 is not limited. For example, it is also possible to first determine whether the condition for the CG-SDT is met, and then determine whether the timing advance or the timing alignment is valid in response to a determination that the condition for the CG-SDT is met.

The UE may determine whether the condition for the CG-SDT is met in the following method, but is not limited to the following method. The UE determines whether a volume of to-be-transmitted data is less than or equal to a preset data volume threshold, the UE determines whether a specified RSRP (such as a cell-level RSRP) is greater than or equal to a preset RSRP threshold, and the UE determines whether a valid uplink CG transmission resource is configured (for example, the uplink CG transmission resource is configured on a carrier selected by the UE). Correspondingly, in response to a determination that the volume of the to-be-transmitted data is less than or equal to the preset data volume threshold, the specified RSRP is greater than or equal to the preset RSRP threshold, and the valid uplink CG transmission resource is configured, the UE determines that the condition for the CG-SDT is met.

Compared with the RA-SDT and the non-SDT, the CG-SDT has a lower power consumption. Therefore, the CG-SDT is preferred for the data transmission in this embodiment to reduce a power consumption of the UE.

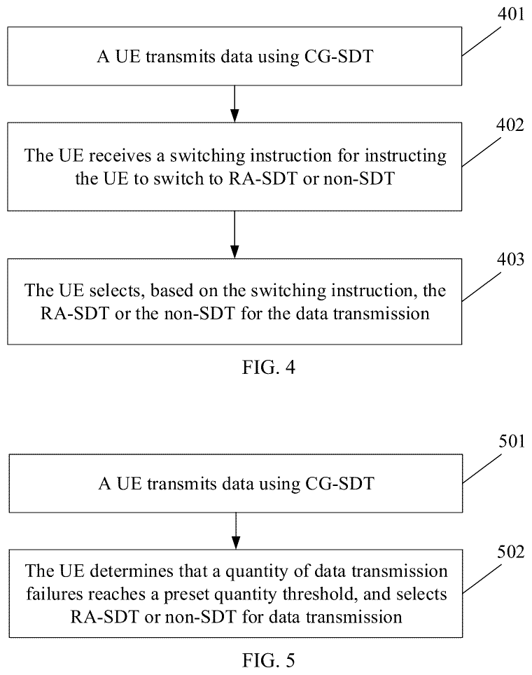

FIG. 4 is a flowchart of a method for processing data according to an embodiment of the present disclosure. As shown in FIG. 4, the method for processing data may include following steps.

In step 401, a UE performs data transmission through CG-SDT.

In step 402, the UE receives a switching instruction. The switching instruction is used to instruct the UE to switch to RA-SDT or non-SDT.

In some embodiments, a network-side device can monitor quality of a PUSCH in the CG-SDT. In response to a determination that the quality of the PUSCH is poor, the network-side device sends the switching instruction to the UE to instruct the UE to switch the data transmission method to the RA-SDT or the non-SDT.

In step 403, based on the switching instruction, the UE selects the RA-SDT or the non-SDT for the data transmission.

FIG. 5 is a flowchart of a method for processing data according to an embodiment of the present disclosure. As shown in FIG. 5, the method for processing data may include following steps.

In step 501, a UE performs data transmission through CG-SDT.

In step 502, the UE determines that a quantity of data transmission failures reaches a preset quantity threshold, and selects RA-SDT or non-SDT for the data transmission.

The UE determines that the quantity of data transmission failures reaches the preset quantity threshold, which indicates that a timing advance or timing alignment may be invalid, and thus the UE autonomously selects the RA-SDT or the non-SDT for the data transmission.

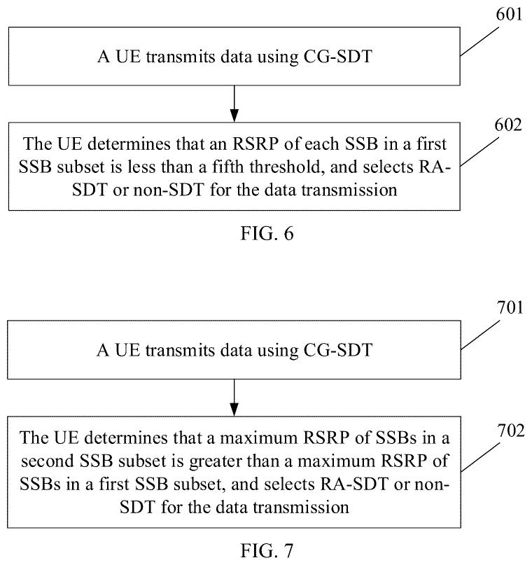

FIG. 6 is a flowchart of a method for processing data according to an embodiment of the present disclosure. As shown in FIG. 6, the method for processing data may include following steps.

In step 601, a UE performs data transmission through CG-SDT.

In step 602, the UE determines that RSRPs of SSBs in a first SSB subset are all less than a fifth threshold, and selects RA-SDT or non-SDT for the data transmission. The first SSB subset is constituted by SSBs associated with the uplink CG transmission resource.

In some scenarios, in order to save an overhead of the uplink CG transmission resource, a network-side device only associates the uplink CG transmission resource with some SSBs in a CG configuration for the UE. For example, there are eight SSBs actually transmitted by a base station in a cell, but the base station only associates four uplink CG transmission resources with four SSBs. The uplink CG transmission resources are only associated with some SSBs. Therefore, the UE can select the RA-SDT or the non-SDT when an RSRP of each associated SSB is less than a threshold, to cause the base station to reconfigure the SSBs associated with the uplink CG transmission resources and improve a signal-to-noise ratio.

FIG. 7 is a flowchart of a method for processing data according to an embodiment of the present disclosure. As shown in FIG. 7, the method for processing data may include following steps.

In step 701, a UE performs data transmission through CG-SDT.

In step 702, the UE determines that a maximum RSRP of SSBs in a second SSB subset is greater than a maximum RSRP of SSBs in a first SSB subset, and selects RA-SDT or non-SDT for the data transmission.

The first SSB subset is constituted by one or more SSBs associated with the uplink CG transmission resource. The maximum RSRP of the SSBs in the first SSB subset refers to a maximum RSRP of RSRPs of all SSBs in the first SSB subset.

The second SSB subset is constituted by one or more SSBs not associated with the uplink CG transmission resource. The maximum RSRP of the SSBs in the second SSB subset refers to a maximum RSRP of RSRPs of all SSBs in the second SSB subset.

When signals of beams corresponding to four SSBs not associated with the uplink CG transmission resources are better for the UE, the UE can initiate a RACH process, which allows a network-side device such as a base station to perform reconfiguration for the UE in advance and associate four uplink CG transmission resources with the four SSBs that were not associated with the uplink CG transmission resources, namely the SSBs in the second SSB subset. For example, SSBs 1 to 4 are associated with the uplink CG transmission resource and SSBs 5 to 8 are not associated with the uplink CG transmission resource. If a maximum RSRP of the SSBs 5 to 8 is greater than a maximum RSRP of the SSBs 1 to 4, the UE can initiate the RACH process, causing the network-side device such as the base station to perform reconfiguration for the UE in advance and associate the four uplink CG transmission resources with the SSBs 5 to 8.

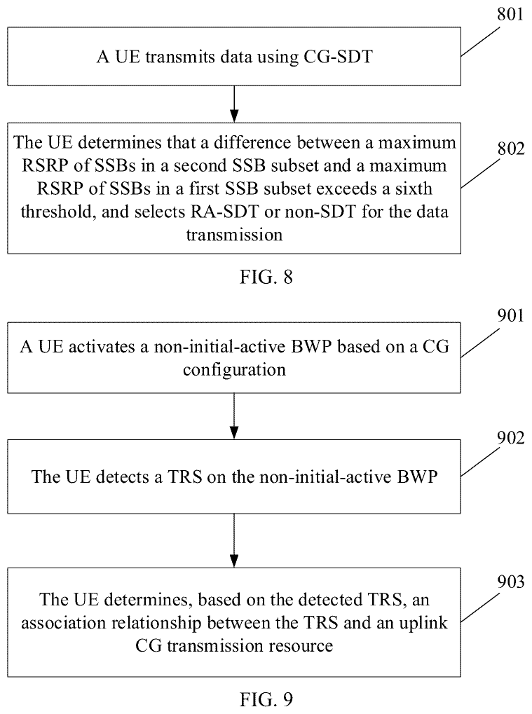

FIG. 8 is a flowchart of a method for processing data according to an embodiment of the present disclosure. As shown in FIG. 8, the method for processing data may include following steps.

In step 801, a UE performs data transmission through CG-SDT.

In step 802, the UE determines that a difference between a maximum RSRP of SSBs in a second SSB subset and a maximum RSRP of SSBs in a first SSB subset exceeds a sixth threshold, and selects RA-SDT or non-SDT for the data transmission.

Different from the method shown in FIG. 7, in response to determining that the difference between the maximum RSRP of the SSBs in the second SSB subset and the maximum RSRP of the SSBs in the first SSB subset exceeds the sixth threshold, the UE initiates a RACH process, allowing a network-side device such as a base station to reconfigure the UE in advance and associate four uplink CG transmission resources with four SSBs that were not associated with a uplink CG transmission resource, namely SSBs in the second SSB subset. This increases robustness.

During a CG-SDT process performed by the UE, under a multi-beam condition, the network-side device such as the base stations configures and activates a non-initial-active BandWidth Part (BWP) for the UE. In response to a determination that there is no SSB on the non-initial active BWP, the UE needs to adjust a radio frequency (RF) to measure an SSB on an initial active BWP to obtain an uplink CG transmission resource corresponding to the SSB, and then uses the uplink CG transmission resource to transmit data. The SSB measurement process increases a power consumption of the UE. Therefore, the present disclosure provides a method for processing data, in which a tracking reference signal is configured on a non-initial-active BWP. In this case, as shown in FIG. 9, the method for processing data may include following steps.

In step 901, a UE activates a non-initial-active BWP based on a CG configuration.

An initial active BWP or an initial active downlink BWP is a BWP configured by a network-side device for the UE during initial access process of the UE The initial active BWP is mainly used for an initial access process, for example, receiving a SIB1, receiving a random access response (RAR) in a random access process, receiving a Msg4, sending a prepare, and sending the Msg4. The non-initial active BWP is a BWP configured by the network-side device for the UE, excluding the initial active BWP.

In step 902, the UE detects a TRS on the non-initial-active BWP.

In step 903, based on the detected TRS, the UE determines an association relationship between the TRS and an uplink CG transmission resource.

A rule for mapping between the TRS and the uplink CG transmission resource may be predefined. For example, the TRS may be first mapped onto a PUSCH DMRS resource index and then a mapped onto transmission occasion in a one-to-one correspondence.

In an embodiment, the UE can determine the association relationship between the TRS and the uplink CG transmission resource based on the CG configuration and the rule for mapping between the TRS and the uplink CG transmission resource.

When the uplink CG transmission resource is associated with no SSB, the uplink CG transmission resource can be associated with the TRS. In this case, a process of selecting the uplink CG transmission resource by the UE is as follows. In response to a determination that a measured value of one TRS exceeds a preset threshold, the UE selects an uplink CG transmission resource associated with the one SSB for uplink transmission.

In another embodiment, the UE can determine the association relationship between the TRS and the uplink CG transmission resource based on the CG configuration, the rule for mapping between the TRS and the uplink CG transmission resource, and a quasi-colocation (QCL) relationship between the TRS and a channel state information reference signal (CSI-RS).

When the uplink CG transmission resource is associated with no SSB, the uplink CG transmission resource can be associated with the TRS. In this case, a process of selecting the uplink CG transmission resource by the UE is as follows. In response to a determination that a measured value of one TRS exceeds a preset threshold, the UE selects an uplink CG transmission resource associated with the one SSB for uplink transmission. The measured value of the one TRS is a measured value (for example, an RSRP) of a CSI-RS that is quasi-colocation with the one TRS.

In another embodiment, the UE can determine the association relationship between the TRS and the uplink CG transmission resource based on the CG configuration, a rule for mapping between an SSB and the uplink CG transmission resource, and a QCL relationship between the TRS and the SSB.

When the uplink CG transmission resource is associated with no SSB, the uplink CG transmission resource can be associated with the TRS. In this case, a process of selecting the uplink CG transmission resource by the UE is as follows. In response to a determination that an RSRP of one SSB exceeds a preset threshold, the UE selects an uplink CG transmission resource associated with a TRS that is quasi-colocation with the one SSB for uplink transmission.

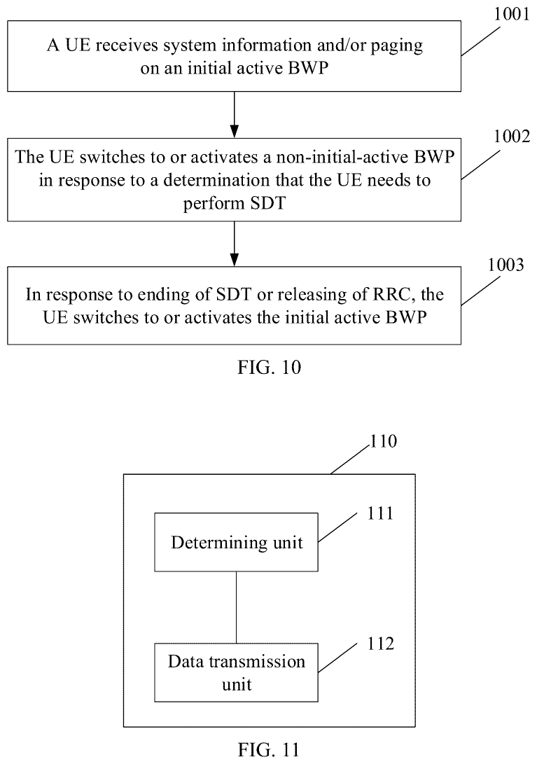

In a process of performing CG-SDT by the UE, under a multi-beam condition, the network-side device such as a base station configures and activates the non-initial-active BWP for the UE. In response to a determination that there is no CORESET0 on the non-initial-active BWP, the network-side device needs to configure an additional CORESET0 on the non-initial-active BWP for the UE to receive system information (SI) and/or paging. This increases a network resource overhead. Therefore, the present disclosure provides a method for processing data. As shown in FIG. 10, the method for processing data may include following steps.

In step 1001, a UE receives SI and/or paging on an initial active BWP.

In step 1002, the UE switches to or activates a non-initial-active BWP in response to a determination that the UE needs to perform SDT.

The non-initial-active BWP is a BWP configured by a network-side device in a CG configuration of the UE for the UE to perform the SDT.

In step 1003, in response to ending of the SDT or releasing of RRC, the UE switches to or activates the initial active BWP.

Further, since the UE only needs to receive the system information and/or the paging on an initial active downlink BWP, the non-initial-active BWP in the steps 1001 to 1003 can be further limited to a non-initial-active downlink BWP.

It can be understood that some or all of the steps or operations in the above embodiments are only examples, and other operations or variants of various operations can further be performed in the embodiments of the present disclosure. In addition, the steps may be performed in orders different from that presented in the foregoing embodiments, and not all the operations in the foregoing embodiments need to be performed.

FIG. 11 is a structural diagram of an apparatus for processing data according to an embodiment of the present disclosure. As shown in FIG. 11, the apparatus 110 may include: a determining unit 111.

The determining unit 111 is configured to: in response to a determination that a change in a first RSRP is less than a first threshold, or in response to a determination that changes in a plurality of first RSRPs are all less than a second threshold, or in response to a determination that changes in a plurality of first RSRPs are less than respective thresholds thereof, determine that a timing advance or timing alignment is valid.

In some embodiments, the apparatus 110 may also include a data transmission unit 112 for data transmission.

In some embodiments, the first RSRP is a linear average RSRP of an SSB subset.

In some embodiments, the SSB subset is constituted by one or more SSBs whose RSRPs exceed a third threshold.

In some embodiments, the third threshold is a threshold used to select an uplink CG transmission resource.

In some embodiments, the SSB subset is constituted by one or more SSBs in a CG configuration.

In some embodiments, the SSB subset is constituted by one or more SSBs in the CG configuration whose RSRPs exceed a fourth threshold.

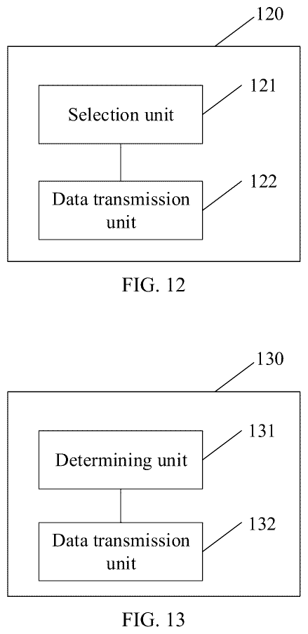

FIG. 12 is a structural diagram of an apparatus for processing data according to an embodiment of the present disclosure. As shown in FIG. 12, the apparatus 120 may include: a selection unit 121.

The selection unit 121 is configured to select RA-SDT or non-SDT.

In some embodiments, the apparatus 120 may also include a data transmission unit 122 for data transmission.

In some embodiments, the selection unit 121 can be specifically configured to select the RA-SDT or the non-SDT in response to a determination that a timing advance or timing alignment is invalid.

In some embodiments, the selection unit 121 can be specifically configured to select the RA-SDT or the non-SDT in response to receiving a switching instruction.

In some embodiments, the selection unit 121 can be specifically configured to select the RA-SDT or the non-SDT autonomously.

In some embodiments, the selection unit 121 can be specifically configured to: in response to a determination that an RSRP of each SSB in a first SSB subset is less than a fifth threshold, select the RA-SDT or the non-SDT. The first SSB subset is constituted by one or more SSBs associated with an uplink CG transmission resource.

In some embodiments, the selection unit 121 can be specifically configured to: in response to a determination a maximum RSRP of SSBs in a second SSB subset is greater than a maximum RSRP of SSBs in a first SSB subset, select the RA-SDT or the non-SDT. The first SSB subset is constituted by one or more SSB associated with an uplink CG transmission resource. The second SSB subset is constituted by one or more SSBs not associated with the uplink CG transmission resource.

In some embodiments, the selection unit 121 can be specifically configured to: in response to a determination that a difference between a maximum RSRP of SSBs in a second SSB subset and a maximum RSRP of SSBs in a first SSB subset is greater than a sixth threshold, select the RA-SDT or the non-SDT. The first SSB subset is constituted by one or more SSBs associated with the uplink CG transmission resource. The second SSB subset is constituted by one or more SSBs not associated with the uplink CG transmission resource.

FIG. 13 is a structural diagram of an apparatus for processing data according to an embodiment of the present disclosure. As shown in FIG. 13, the apparatus 130 may include: a determining unit 131.

The determining unit 131 is configured to determine an association relationship between a TRS and an uplink CG transmission resource.

In some embodiments, the apparatus 130 may also include a data transmission unit 132 for data transmission.

In some embodiments, the determining unit 131 can be specifically configured to determine the association relationship between the TRS and the uplink CG transmission resource based on a CG configuration.

In some embodiments, the determining unit 131 can be specifically configured to determine the association relationship between the TRS and the uplink CG transmission resource based on a CG configuration and a rule for mapping between the TRS and the uplink CG transmission resource.

In some embodiments, the determining unit 131 can be specifically configured to determine the association relationship between the TRS and the uplink CG transmission resource based on a CG configuration, a rule for mapping between an SSB and the uplink CG transmission resource, and a QCL relationship between the TRS and the SSB.

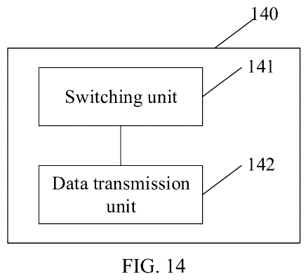

FIG. 14 is a structural diagram of an apparatus for processing data according to an embodiment of the present disclosure. As shown in FIG. 14, the apparatus 140 may include: a switching unit 141.

The switching unit 141 is configured to switch a BWP.

In some embodiments, the apparatus 140 may also include a data transmission unit 142 for data transmission.

In some embodiments, the switching unit 141 can be specifically configured to: switch to or activate a non-initial-active BWP after SDT is initiated.

In some embodiments, the switching unit 141 can be specifically configured to: switch to an initial active BWP or activate a non-initial-active BWP in response to ending of the SDT or releasing of RRC.

In some embodiments, the switching unit 141 can be specifically configured to: switch to or activate a non-initial-active downlink BWP after SDT is initiated.

In some embodiments, the switching unit 141 can be specifically configured to: switch to an initial downlink BWP or activate a non-initial-active downlink BWP in response to ending of the SDT or releasing of RRC.

The apparatus provided in the embodiments shown in FIG. 11 to FIG. 14 can be configured to execute the technical solutions of the method embodiments shown in FIG. 1 to FIG. 10. For an implementation principle and a technical effect of the apparatus, reference may be further made to the related description of the method embodiments.

It should be understood that the unit division of the apparatus shown in FIG. 11 to FIG. 14 is merely logical function division. In actual implementation, the units may be fully or partially integrated into a physical entity, or may be physically separated. These units may be all implemented in a form of software through processing element calling; may be all implemented in a form of hardware; or may be partially implemented in a form of software through processing element calling, and partially implemented in a form of hardware. For example, the determining unit may be a separate processing element or integrated into a chip of an electronic device. Other units are implemented in a similar way. In addition, these units may be fully or partially integrated, or implemented independently. For example, the foregoing data transmission apparatus may be a chip or a chip module, or may be a part of a chip or a chip module. During the implementation, each step of the foregoing method or each of the foregoing units may be performed through an integrated logic circuit of hardware in a processing element or through an instruction in a form of software.

For example, the foregoing modules may be one or more integrated circuits configured to implement the foregoing methods, such as one or more application-specific integrated circuits (ASICs), one or more digital signal processors (DSPs), or one or more field-programmable gate arrays (FPGAs). For another example, these modules may be integrated and implemented in a form of a system-on-a-chip (SOC).

The present disclosure provides a UE, including a processor and a transceiver. The processor and the transceiver cooperate to implement the methods provided in the embodiments shown in FIG. 1 to FIG. 10 of the present disclosure.

The present disclosure further provides a UE, including a storage medium and a central processing unit (CPU). The storage medium may be a non-volatile storage medium, and stores a computer executable program. The CPU is connected to the non-volatile storage medium and executes the computer executable program to implement the methods provided in the embodiments shown in FIG. 1 to FIG. 10 of the present disclosure.

The embodiments of the present disclosure further provide a computer-readable storage medium. The computer-readable storage medium stores a computer program. The computer program is executed by a computer to perform the methods provided in the embodiments shown in FIG. 1 to FIG. 10 of the present disclosure.

The embodiments of the present disclosure further provide a computer program product. The computer program product includes a computer program. The computer program is executed by a computer to perform the methods provided in the embodiments shown in FIG. 1 to FIG. 10 of the present disclosure.

In the present disclosure, the term “at least one” refers to one or more, and the term “multiple” refers to two or more. The term “and/or” describes associations between associated objects, and it indicates three types of relationships. For example, “A and/or B” may indicate that A alone, A and B, or B alone. “A” and “B” each may be singular or plural. The character “/” usually indicates an “or” relationship between associated objects. The term “at least one of the followings” or a similar expression refers to any combination of these items, including any combination of single items or plural items. For example, at least one of a, b, and c may represent: a, b, c, a and b, a and c, b and c, or a, b, and c, wherein a, b, and c may be singular or plural.

Those of ordinary skill in the art may be aware that units and algorithm steps described in the embodiments of the present disclosure can be implemented by electronic hardware or a combination of computer software and electronic hardware. Whether these functions are implemented by hardware or software depends on specific applications of the technical solutions and design constraints. A person skilled in the art may use different methods to implement the described functions for each specific application, but such implementation should not be considered to be beyond the scope of the present disclosure.

A person skilled in the art can clearly understand that for convenience and brevity of description, reference may be made to corresponding processes in the foregoing method embodiments for specific working processes of the foregoing systems, apparatuses, and units. Details are not described herein again.

In the embodiments provided in the present disclosure, if implemented in a form of a software functional unit and sold or used as a stand-alone product, any function may be stored in a computer-readable storage medium. Based on this understanding, the technical solution of the present disclosure essentially, or a part contributing to the prior art, or some of the technical solutions may be embodied in a form of a software product. The computer software product is stored on a storage medium, and includes several instructions to enable a computer device (which may be a personal computer, a server, a network device, or the like) to execute all or some steps of the methods according to the embodiments of the present disclosure. The foregoing storage medium includes: any medium that can store program code, such as a USB flash disk, a removable hard disk, a read-only memory (ROM), a random access memory (RAM), a magnetic disk, or an optical disc.

The above merely describes specific implementations of the present disclosure. Any person skilled in the art can easily conceive modifications or replacements within the technical scope of the present disclosure, and these modifications or replacements shall fall within the protection scope of the present disclosure. Therefore, the protection scope of the present disclosure should be subject to the protection scope of the claims.

1-18. (canceled)

19. A method for processing data, comprising: switching a bandwidth part (BWP).

20. The method according to claim 19, wherein the switching the BWP comprises:
in response to initiating of a SDT, switching to or activating a non-initial active BWP.

21. The method according to claim 19, wherein the switching the BWP comprises:
in response to ending of a SDT or releasing of radio resource control (RRC), switching to an initial active BWP or activating a non-initial-active BWP.

22. The method according to claim 19, wherein the switching the BWP comprises:
in response to initiating of a SDT, switching to or activating a non-initial-active downlink BWP.

23. The method according to claim 19, wherein the switching the BWP comprises:
in response to ending of a SDT or releasing of RRC, switching to an initial active downlink BWP or activating a non-initial-active downlink BWP.

24-28. (canceled)

29. A user equipment (UE), comprising:
one or more processors, a memory, and one or more computer programs, wherein the one or more computer programs are stored in the memory and comprise instructions, and the instructions, when executed by the UE, cause the UE to perform a method for processing data, wherein the method comprises switching a BWP.

30. A non-transitory computer-readable storage medium, wherein the computer-readable storage medium stores a computer program, and the computer program, when running a computer, causes the computer to perform a method for processing data, wherein the method comprises switching a BWP.

31-32. (canceled)

33. The UE according to claim 29, wherein the switching the BWP comprises: in response to initiating of a SDT, switching to or activating a non-initial active BWP.

34. The UE according to claim 29, wherein the switching the BWP comprises: in response to ending of a SDT or releasing of RRC, switching to an initial active BWP or activating a non-initial-active BWP.

35. The UE according to claim 29, wherein the switching the BWP comprises: in response to initiating of a SDT, switching to or activating a non-initial-active downlink BWP.

36. The UE according to claim 29, wherein the switching the BWP comprises: in response to ending of a SDT or releasing of RRC, switching to an initial active downlink BWP or activating a non-initial-active downlink BWP.

37. The computer-readable storage medium according to claim 30, wherein the switching the BWP comprises: in response to initiating of a SDT, switching to or activating a non-initial active BWP.

38. The computer-readable storage medium according to claim 30, wherein the switching the BWP comprises: in response to ending of a SDT or releasing of RRC, switching to an initial active BWP or activating a non-initial-active BWP.

39. The computer-readable storage medium according to claim 30, wherein the switching the BWP comprises: in response to initiating of a SDT, switching to or activating a non-initial-active downlink BWP.

40. The computer-readable storage medium according to claim 30, wherein the switching the BWP comprises: in response to ending of a SDT or releasing of RRC, switching to an initial active downlink BWP or activating a non-initial-active downlink BWP.
